(19) United States
(12) Patent Application Publication
(10) Pub. No.: US 2026/0189142 A1
(43) Pub. Date: Jul. 2, 2026

(54) CONTROLLER AND CONTROL METHOD FOR CONVERTER INCLUDING MULTIPLE PFC CIRCUITS

(71) Applicant: HYUNDAI AUTOEVER CORP., Seoul (KR)

(72) Inventors: Woo Won Rhee, Seoul (KR); Eun Su Jun, Seoul (KR)

(73) Assignee: HYUNDAI AUTOEVER CORP., Seoul (KR)

(21) Appl. No.: 19/435,434

(22) Filed: Dec. 29, 2025

(30) Foreign Application Priority Data
Dec. 30, 2024 (KR) 10-2024-0200632

(51) Int. Cl. H02M 3/157; H02M 1/42; H02M 3/158

(52) U.S. Cl. CPC H02M 3/157; H02M 1/4208; H02M 3/158

(57) ABSTRACT

A converter controller includes a first core configured, in each control period, to calculate pulse width modulation (PWM) control values for first switches included in a first power factor correction (PFC) circuit and store the PWM control values for the first switches in a first data variable; a second core configured, in each control period, to calculate PWM control values for second switches included in a second PFC circuit and store the PWM control values for the second switches in a second data variable; and a third core configured, in an Interrupt Service Routine (ISR) triggered by a core that stores the PWM control values later, to configure registers for PWM signal output to the first switches based on a value of the first data variable and configure registers for PWM signal output to the second switches based on a value of the second data variable.

### CROSS REFERENCE TO RELATED APPLICATION

This application claims the benefit of and priority to Korea Patent Application No. 10-2024-0200632, filed on Dec. 30, 2024, the entire contents of which are hereby incorporated herein by reference.

### FIELD OF TECHNOLOGY

The present disclosure relates to a control technology for a converter including a power factor correction (PFC) circuit.

### BACKGROUND

An electric vehicle may include an on-board charger (OBC). The OBC may be a device that converts alternating current (AC) electricity supplied from an external power source into direct current (DC) electricity, which is usable within the vehicle. This device can provide converted power with a voltage and current suitable for the electric vehicle's battery pack. Additionally, the OBC may perform a function for controlling current and voltage during a power conversion process, thereby preventing overcharging of and damage to the battery.

The on-board charger (OBC) may include a power factor correction (PFC) circuit. The PFC circuit may be designed to maintain a consistent power factor for the alternating current (AC) supplied from an external power source. This circuit may operate by aligning the input current and the input voltage in phase, thereby improving the efficiency of electricity flow and reducing power loss. Additionally, the PFC circuit may include a filtering function to reduce electromagnetic interference with a power grid. This circuit may also improve the input current waveform of the OBC and enable stable power supply during a battery charging process.

The power factor correction (PFC) circuit may have limitations in the capacity of power it can handle. One of the factors determining the maximum power the circuit can process is the capacity of the switches included in the PFC circuit. The switch capacity may be set according to the current and voltage limits, and if the switches operate beyond their design specifications, overheating or damage may occur. Additionally, the capacity of the input filter included in the PFC circuit may also affect the power capacity. The input filter is designed to reduce electromagnetic interference from power coming into the circuit, and if the filter capacity is limited, the filter performance may degrade under high-power conditions. The capacity of the power lines can also influence the power limit of the circuit; if the power lines reach an overload state, stable power delivery may become difficult. These factors may vary depending on the design and configuration of the PFC circuit.

To increase the power capacity of the power factor correction (PFC) circuit, multiple PFC circuits may be arranged in parallel within the on-board charger (OBC). Each of the PFC circuits arranged in parallel may independently process power, thereby enabling the entire PFC system to support a higher power capacity than a single circuit. This configuration can reduce the power load borne by each PFC circuit, lowering the likelihood of overheating or overloading each individual circuit. Furthermore, in a parallel structure, even if a specific circuit fails, the remaining circuits may continue to operate, potentially maintaining system stability.

To operate multiple power factor correction (PFC) circuits in parallel, it may be necessary to synchronize the control periods, switching periods, or duty cycles of two PFC circuits. Synchronizing the control periods may mean adjusting the control signals of the PFC circuits to operate at the same time intervals. Synchronizing the switching periods may refer to setting the on and off periods of the power switches in each circuit to keep them equal. Synchronizing the duty cycles may mean controlling each PFC circuit to maintain the same duty cycle. Such synchronization may serve as a method to minimize current and voltage imbalance between the parallel-connected circuits. If synchronization is not achieved, a specific circuit may end up handling excessive power, potentially leading to overheating or performance degradation.

The subject matter described in this background section is intended to promote an understanding of the background of the disclosure and thus may include subject matter that is not already known to those of ordinary skill in the art.

### SUMMARY

In one aspect, the present disclosure is directed to providing a technology for synchronously controlling a plurality of power factor correction (PFC) circuits. In another aspect, the present disclosure is directed to providing a technology that ensures data coherence when a plurality of PFC circuits is controlled by different cores.

To accomplish the foregoing aspects, an embodiment of the present disclosure provides a converter controller including a first core configured, in each control period, to calculate pulse width modulation (PWM) control values for first switches included in a first power factor correction (PFC) circuit and store the PWM control values for the first switches in a first data variable. The converter controller further includes a second core configured, in each control period, to calculate PWM control values for second switches included in a second PFC circuit and store the PWM control values for the second switches in a second data variable. The converter controller further includes a third core configured, in an Interrupt Service Routine (ISR) triggered by a core that stores the PWM control values later, of the first core and the second core, to configure registers for PWM signal output to the first switches based on the value of the first data variable and configure registers for PWM signal output to the second switches based on a value of the second data variable.

The first core and the second core may check and change a value of a state variable to determine which core stores first and which core stores later.

The first core and the second core may use a spinlock when changing the value of the state variable.

The first core and the second core each may determine whether the state variable holds a first value. When the state variable does not hold the first value, the first core and the second core may trigger the ISR.

When the state variable holds the first value, the first core may change the state variable to a second value. When the state variable holds the second, the second core may trigger the ISR.

The state variable may include a first value indicating an initial state, a second value indicating that the PWM control values for the first switches are stored in the first data variable, a third value indicating that the PWM control values for the second switches are stored in the second data variable, and a fourth value indicating that the PWM control values for the first switches are stored in the first data variable. The PWM control values for the second switches are stored in the second data variable.

A core that triggers the ISR may store the value of the first data variable and the value of the second data variable in variables located in a random access memory (RAM) area of the third core, and then triggers the ISR.

The core that triggers the ISR may use a spinlock when storing the value of the first data variable and the value of the second data variable in variables located in the RAM area of the third core.

The third core may calculate register values for PWM signal output based on the values of the variables located in the RAM area of the third core and may configure the registers for PWM signal output using the register values.

The third core may use a spinlock when checking the values of the variables located in the RAM area of the third core.

The third core may generate a rising edge time value or a falling edge time value of the PWM signal from the value of a variable located in the RAM area of the third core and may store the rising edge time value or the falling edge time value in the registers for PWM signal output.

The PWM control values may include at least one of a value indicating a duty cycle of the PWM signal or a value indicating a period of the PWM signal.

The converter controller may further include timer output modules (TOMs) that output a PWM signal to the first switches and the second switches. The third core may configure shadow register (SR) respectively corresponding to the TOMs.

Each TOM may include a first CM register used for setting a rising edge of the PWM signal and a second CM register used for setting a falling edge of the PWM signal. Value stored in the shadow register are transmitted to the first CM register and the second CM register at a start of a control period.

The TOMs may be located in a Generic Timer Module (GTM), and the third core may be a Multi Channel Sequencer (MCS) located in the GTM.

The first core may perform, in each control period, acquire sensing values from an Analog-to-Digital Converter (ADC) for the first power factor correction (PFC) circuit; may perform a voltage control process; may perform a current control process; and then may calculate the PWM control values for the first switches. The second core may, in each control period, acquire sensing values from an ADC for the second PFC circuit; perform a voltage control process; perform a current control process; and may determine the PWM control values for the second switches.

Another embodiment of the present disclosure provides a converter control method including calculating, by a first core, pulse width modulation (PWM) control values for first switches included in a first power factor correction (PFC) circuit. The converter control method further includes determining, by a second core, PWM control values for second switches included in a second PFC circuit. The converter control method further includes storing, by the first core, the PWM control values for the first switches in a first data variable. The converter control method further includes determining, by the first core, a value of a state variable. The converter control method further includes changing, by the first core, the value of the state variable to a second value based on the value of the state variable being a first value or changing, by the first core, the value of the state variable to a fourth value based on the value of the state variable being a third value. The converter control method further includes storing, by the second core, the PWM control values for the second switches in a second data variable and checking the value of the state variable. The converter control method further includes changing, by the second core, the value of the state variable to the third value based on the value of the state variable is the first value or changing, by the second core, the value of the state variable to the fourth value based on the value of the state variable being the second value. The converter control method further includes configuring, by a third core, registers for PWM signal output to the first switches based on a value of the first data variable. The converter control method further includes configuring, by the third core, registers for PWM signal output to the second switches based on a value of the second data variable. The converter control method further includes triggering an Interrupt Service Routine (ISR) of the third core by the core that changes the value of the state variable to the fourth value.

The converter control method further includes, before triggering the ISR of the third core, storing, by a core that changes the value of the state variable to the fourth value, the value of the first data variable and the value of the second data variable in variables located in a random access memory (RAM) area of the third core.

The converter control method further includes locking, by a core that changes the value of the state variable to the fourth value may lock a spinlock. The converter control method further includes storing, by the core that changes the value of the state variable to the fourth value, the value of the first data variable and the value of the second data variable in variables located in the RAM area of the third core.

The converter control method further includes locking, by the first core and the second core a spinlock and determining, by the first core and the second core, the value of the state variable.

As described above, according to the present disclosure, it is possible to synchronously control a plurality of power factor correction (PFC) circuits. Furthermore, according to the present disclosure, data coherence can be ensured when a plurality of PFC circuits is controlled by different cores.

### BRIEF DESCRIPTION OF THE DRAWINGS

FIG. 1 is a schematic diagram of a converter according to an embodiment.

FIG. 2 is a schematic diagram of a power factor correction (PFC) power stage according to one embodiment.

FIG. 3 is a waveform diagram of a first PWM a-phase signal and a second pulse width modulation (PWM) a-phase signal according to one embodiment.

FIG. 4 is a schematic diagram illustrating elements that determine control values of each PWM signal in one embodiment.

FIG. 5 illustrates an example diagram showing a control process performed by a single core during one control period.

FIG. 6 is a schematic diagram illustrating a problem that may arise when a single core simultaneously controls two PFC circuits during one control period.

FIG. 7 is a schematic diagram illustrating how two cores in a converter controller according to one embodiment control respective PFC circuits.

FIG. 8 is a schematic diagram of a converter controller according to one embodiment.

FIG. 9 is a schematic diagram of a timer output module (TOM) channel according to an embodiment.

FIG. 10 is a schematic diagram illustrating a procedure for cores to perform processes and waveforms of primary signals according to one embodiment.

FIG. 11 is a flowchart illustrating a converter control method according to one embodiment.

FIG. 12 is a detailed flowchart of step S1104 in the flowchart in FIG. 11.

FIG. 13 is a detailed flowchart of step S1106 in the flowchart in FIG. 11.

FIG. 14 is a detailed flowchart of step S1108 in the flowchart in FIG. 11.

The drawings described herein are for illustration purposes only and are not intended to limit the scope of the present disclosure in any way.

### DETAILED DESCRIPTION

Hereinafter, embodiments of the present disclosure are described in detail with reference to drawings. It should be noted that, in assigning reference numerals to components in the drawings, the same components are given the same numerals as much as possible, even if they are shown in different drawings. Furthermore, in describing the present disclosure, detailed explanations of well-known components or functions may be omitted if they are deemed to obscure the gist of the disclosure.

In describing the components of the present disclosure, terms such as first, second, A, B, (a), (b), and the like may be used. These terms are merely intended to distinguish one component from another, and the essence, sequence, or order of the components are not limited by the terms. Furthermore, when a component is described as being “connected”, “coupled”, or “interfaced” to another component, it should be understood that the component may be directly connected or interfaced to another component or that the component may also be “connected”, “coupled”, or “interfaced” to another component via yet another component provided therebetween. When a controller, module, component, device, element, unit, part, portion, “-er,” or the like of the present disclosure is described as having a purpose or performing an operation, function, or the like, the controller, module, component, device, element, unit, part, portion, “-er,” or the like should be considered herein as being “configured to” meet that purpose or to perform that operation or function. Each controller, module, component, device, element, unit, part, portion, “-er,” and the like may separately embody or be included with a processor and a memory, such as a non-transitory computer readable media, as part of the apparatus.

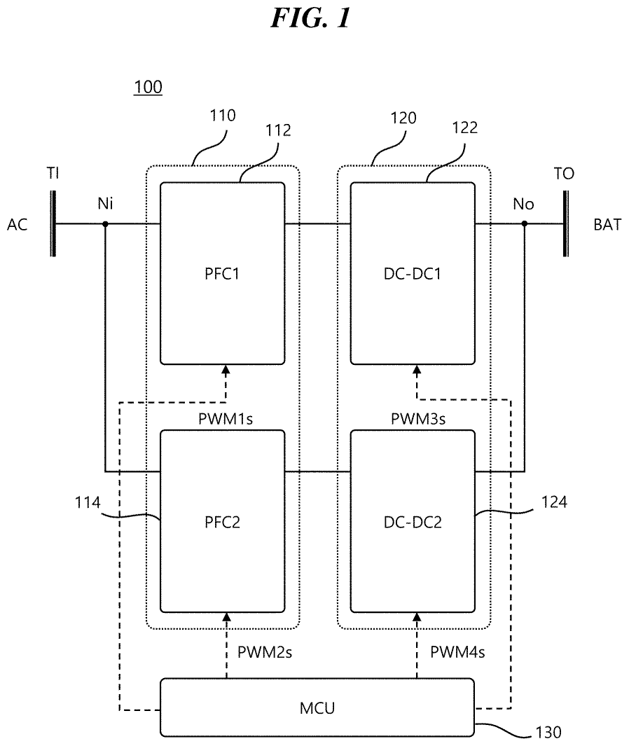

FIG. 1 is a configuration diagram of a converter according to an embodiment.

Referring to FIG. 1, the converter 100 may include a power factor correction (PFC) power stage 110, a DC/DC power stage 120, and a converter controller 130.

The converter 100 may be an on-board charger (OBC). When the converter 100 is an OBC, the load connected to the converter 100 may be a battery (BAT).

The converter 100 may be an on-board charger (OBC). The converter 100 may be a power conversion device installed in an electric vehicle, capable of converting alternating current (AC) electricity supplied from an external power source into direct current (DC) electricity to provide the power required for battery charging. The OBC may monitor the battery's charging status and control the charging current and voltage to prevent damage caused by overcharging or overcurrent. Additionally, the OBC may be designed to operate reliably under various input voltage conditions, and may include a power factor correction (PFC) function to reduce interference with a power grid.

The load connected to the converter 100 may be a battery (BAT). The battery (BAT) may serve as a primary energy storage device in an electric vehicle, and lithium-ion based battery cells may be commonly used. The battery (BAT) stores the power converted by the converter 100, and the stored energy may be used to drive the electric vehicle's motor and supply power to other electronic devices. The battery (BAT) may be designed to repeat charging and discharging processes, and a battery management system (BMS) may be used to monitor conditions such as temperature, voltage, and current.

In the converter 100, the PFC power stage 110 may receive alternating current power and convert it into direct current power. The DC/DC power stage 120 may regulate the voltage or current level of the direct current power supplied from the PFC power stage 110 and provide it to the load.

The DC/DC power stage 120 may include a plurality of DC/DC converting circuits 122 and 124. The DC/DC converting circuits 122 and 124 may be power conversion circuits capable of converting the voltage or current of the input direct current power to generate a voltage or current suitable for the load. These circuits may be designed to improve power transfer efficiency and adjust power according to the requirements of the load.

The DC/DC converting circuits 122 and 124 may be step-down converting circuits which convert the output voltage to a level lower than the input voltage. The step-down converting circuits may primarily employ a buck converter structure, and may convert the input voltage into a lower voltage suitable for the load through controlled switching operations. This conversion may minimize power loss, and may enable stable power supply within a voltage acceptance range of the load.

The DC/DC converting circuits 122 and 124 may be step-up converting circuits which convert the output voltage to a level higher than the input voltage. The step-up converting circuits may primarily employ a boost converter structure, and may convert a low input voltage into a higher output voltage by utilizing switching operations and energy storage components. This circuit may be designed to provide the voltage required for the load even when the input voltage is low.

The DC/DC converting circuits 122 and 124 may be designed not only for step-down and step-up conversion, but also to support bidirectional power conversion. In such cases, they may include a function for adjusting voltage and current according to the direction of power flow.

The PFC power stage 110 may include a plurality of PFC circuits 112 and 114, and in this case, the DC/DC converting circuits 122 and 124 may operate in connection with the PFC circuits 112 and 114, respectively.

The PFC circuits 112 and 114 are circuits that receive alternating current power and convert it into direct current power. These circuits may rectify and filter alternating current (AC) power inputted from an external source to convert it into direct current (DC) power that can be used for electrical loads. The PFC circuits 112 and 114 may include a function for correcting power factors by adjusting the phases of the input current and input voltage during the power conversion process.

The PFC circuits 112 and 114 may be designed to adjust the waveform of the input current so that it remains in phase with the input voltage. This enables efficient use of power supplied from the power grid and helps reduce power loss and electromagnetic interference. To implement such power factor correction, the PFC circuits 112 and 114 may adopt an active PFC method.

In the case of the active PFC method, the PFC circuits 112 and 114 may include switches, and the converter controller 130 may control these switches to dynamically adjust the input current and perform precise power factor correction.

A plurality of switches may be arranged in the PFC circuits 112 and 114 and the DC/DC converting circuits 122 and 124. The switches may include, for example, Metal-Oxide-Semiconductor Field-Effect Transistors (MOSFETs), Insulated Gate Bipolar Transistors (IGBTs), or Bipolar Junction Transistors (BJTs).

A MOSFET is a device that can control the current between drain and source by applying a voltage between gate and source. The MOSFET may be a voltage-controlled device, and channel conductivity may be adjusted according to the voltage applied to the gate. The drain-source current is determined by the gate voltage, and due to their excellent switching characteristics, the MOSFET is widely used in switching applications.

An IGBT is a device that combines the characteristics of MOSFET and BJT, and it may control the collector-emitter current by applying a voltage between gate and emitter. The IGBT is capable of handling high voltages, and its structure may possess the input characteristics of MOSFET and the output characteristics of BJT. Due to these characteristics, the IGBT can be used in applications.

A BJT is a device including three terminals: base, collector, and emitter, that controls the current between collector and emitter by applying a base current. The BJT is a current-controlled device, and the collector current may be amplified by the base current. Due to this amplification characteristic, the BJT can be used in current amplifiers and has the advantage of handling high current in specific applications.

The converter controller 130 may control these switches using Pulse Width Modulation (PWM). Through this PWM control, the converter controller 130 may control the duty cycle of each switch and control the switching period or switching frequency of each switch.

PWM control may be a method of generating desired output voltage or current by adjusting the ON time and OFF time of the switches. Through this PWM control, the converter controller 120 may adjust the duty cycle of each switch. The duty cycle represents the ratio of the time during which the switch is ON, and can be used to control the amplitude of the output power.

The converter controller 130 may control not only the duty cycle but also the switching period or switching frequency of each switch. The switching period may refer to the time it takes for a switch to turn on and off once, and the switching frequency may refer to the number of times a switching operation is repeated per second. Controlling the switching period or frequency can affect the quality of the output power and the efficiency of power conversion, and may also be related to thermal management of power devices.

The converter controller 130 may include a circuit or algorithm capable of monitoring input signals of voltage, current, and temperature. and generating PWM signals based on the input signals, in order to adjust the states of the switches in real time.

Alternating current (AC) power may be supplied to an input terminal TI of the converter 100, and a load—for example, a battery BAT—may be connected to an output terminal TO of the converter 100. Furthermore, an input node Ni may be formed at the input terminal TI, and an output node No may be formed at the output terminal TO.

The first PFC circuit 112 and the second PFC circuit 114 may share the input node Ni, and the first DC/DC converting circuit 122 and the second DC/DC converting circuit 124 may share the output node No. The first PFC circuit 112 may convert the alternating current power formed at the input node Ni into direct current power and may supply it to the first DC/DC converting circuit 122, and the first DC/DC converting circuit 122 may then convert the voltage or current of the direct current power and supply it to the output node No. The second PFC circuit 114 may convert the alternating current power formed at the input node Ni into direct current power and may supply it to the second DC/DC converting circuit 124, and the second DC/DC converting circuit 124 may then convert the voltage or current of the direct current power and supply it to the output node No.

For the power conversion of each circuit 112, 114, 122, and 124, the converter controller 130 may output a first PWM signal (PWM1s) to the first PFC circuit 112, and a second PWM signal (PWM2s) to the second PFC circuit 114. Additionally, the converter controller 130 may output a third PWM signal (PWM3s) to the first DC/DC converting circuit 122 and a fourth PWM signal (PWM4s) to the second DC/DC converting circuit 124.

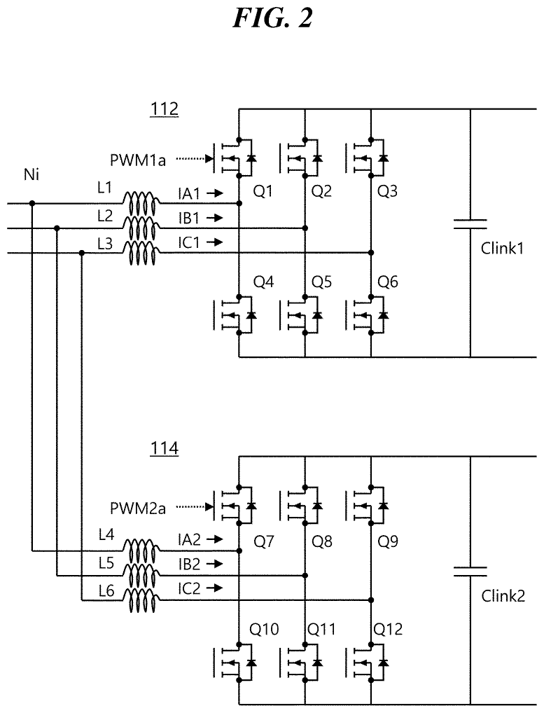

FIG. 2 is a configuration diagram of a PFC power stage according to one embodiment.

Referring to FIG. 2, the PFC power stage may include a first PFC circuit 112 and a second PFC circuit 114. The first PFC circuit 112 and the second PFC circuit 114 may share the input node Ni.

The power supplied to the input node Ni may be three-phase power. Depending on the embodiment, the power supplied to the input node Ni may be single-phase power; however, for the convenience of explanation, it is described hereinafter as three-phase power being supplied to the input node Ni.

An input filter may be disposed in each PFC circuit 112 and 114. A first inductor L1 may be disposed on A-phase of the first PFC circuit 112, a second inductor L2 may be disposed on B-phase thereof, and a third inductor L3 may be disposed on C-phase thereof. A fourth inductor L4 may be disposed on A-phase of the second PFC circuit 114, a fifth inductor L5 may be disposed on B-phase thereof, and a sixth inductor L6 may be disposed on C-phase thereof.

In each PFC circuit 112 and 114, a pair of switches may be connected to each phase. In the first PFC circuit 112, a first switch Q1 and a fourth switch Q4 may be disposed on A-phase, a second switch Q2 and a fifth switch Q5 may be disposed on B-phase, and a third switch Q3 and a sixth switch Q6 may be disposed on C-phase. In the second PFC circuit 114, a seventh switch Q7 and a tenth switch Q10 may be disposed on A-phase, an eighth switch Q8 and an eleventh switch Q11 may be disposed on B-phase, and a ninth switch Q9 and a twelfth switch Q12 may be disposed on C-phase.

The converter controller may supply PWM signals to the gates of the switches Q1 to Q12 to control the ON/OFF of the switches Q1 to Q12. For example, the converter controller may supply a first PWM a-phase signal (PWM1a) to the gate of the first switch Q1 to control the ON/OFF of the first switch Q1. The converter controller may supply a second PWM a-phase signal (PWM2a) to the gate of the seventh switch Q7 to control the ON/OFF of the seventh switch Q7.

Based on the ON/OFF of the switches Q1 to Q12, phase currents IA1, IB1, IC1, IA2, IB2, and IC2 may be converted into direct current and temporarily stored in DC link capacitors Clink1 and Clink2. For example, based on the ON/OFF of the switches Q1 through Q6, the phase currents IA1, IB1, and IC1 of the first PFC circuit 112 may be converted into direct current and temporarily stored in the first DC link capacitor Clink1. Based on the ON/OFF of the switches Q7 through Q12, the phase currents IA2, IB2, and IC2 of the second PFC circuit 114 may be converted into direct current and temporarily stored in the second DC link capacitor Clink2.

In this instance, the switches Q1 to Q6 of the first PFC circuit 112 and the switches Q7 to Q12 of the second PFC circuit 114 may operate in such a manner that control values have coherence. Here, coherence may mean that the control values are updated in the same cycle.

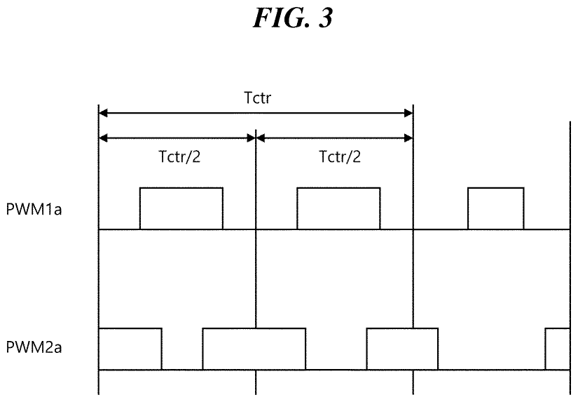

FIG. 3 is a waveform diagram of a first PWM a-phase signal and a second PWM a-phase signal according to one embodiment.

Referring to FIG. 3, the first PWM a-phase signal (PWM1a) and the second PWM a-phase signal (PWM2a) may be updated for the same control period Tctr. For example, the duty cycles of the first PWM a-phase signal (PWM1a) and the second PWM a-phase signal (PWM2a) may be changed for the same control period Tctr. In the example shown in FIG. 3, the first PWM a-phase signal (PWM1a) and the second PWM a-phase signal (PWM2 a) have a phase difference of 180 degrees, but the control periods Tctr of the two signals may be substantially the same.

In the example of FIG. 3, one control period Tctr may include two switching periods Tctr/2, and both the first PWM a-phase signal (PWM1a) and the second PWM a-phase signal (PWM2a) may have the same switching period Tctr/2.

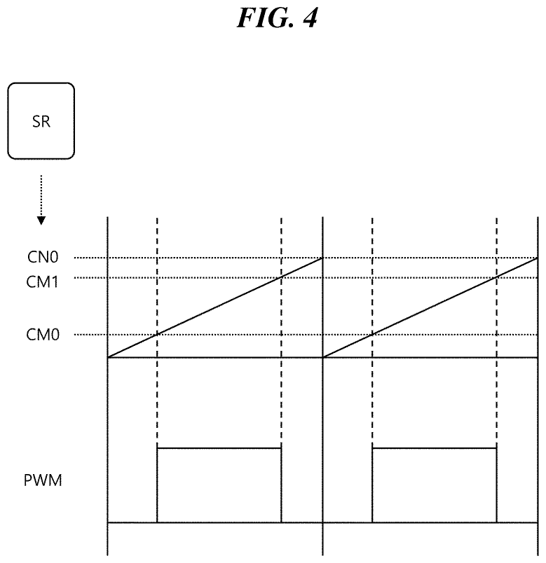

FIG. 4 is a diagram illustrating elements that determine control values of each PWM signal in one embodiment.

Referring to FIG. 4, the control values of a PWM signal may include duty cycle and period. The converter controller may perform PWM control on each switch to control the output of each PFC circuit, where PWM control may refer to controlling the duty cycle and period of a PWM signal.

Meanwhile, the converter controller may use a timer and registers to control the duty cycle and period of a PWM signal.

For example, the converter controller may include a timer, and the period of a PWM signal may be determined by comparing the timer value with the value of a first CN register CN0. The timer may count up from an initial value (e.g., 0), incrementing at fixed intervals, and when its value becomes equal to the value of the first CN register CN0, it may return to the initial value. In this method, the period of the PWM signal may be determined by the value of the first CN register CN0.

As another example, the converter controller may set the rising edge of the PWM signal when the timer value becomes equal to the value of the first CM register CM0, and the converter controller may set the falling edge of the PWM signal when the timer value becomes equal to the value of the second CM register CM1. In this method, the duty cycle of the PWM signal may be determined by the value of the first CM register CM0 and the value of the second CM register CM1.

The converter controller may calculate control values (e.g., duty cycle and period) for each PWM signal and then may calculate the register values based on those control values. The controller may then update the registers with the calculated values to control each PWM signal.

At this time, the converter controller may use a shadow register SR to synchronize the timing at which the registers are updated and controlled with coherence. After calculating the control values (e.g., duty cycle and period) for each PWM signal, the converter controller may store these values first in the shadow register SR. Then, the converter controller may be configured so that the values stored in the shadow register SR are transmitted to the registers CN0, CM0, and CM1 at the start of the next control period. This method prevents the registers from being updated arbitrarily and helps maintain them with coherence.

The converter controller may include a core for calculation. This core may execute a control algorithm to calculate control values for each PWM signal. Based on these control values, it may derive register values and then update the shadow register.

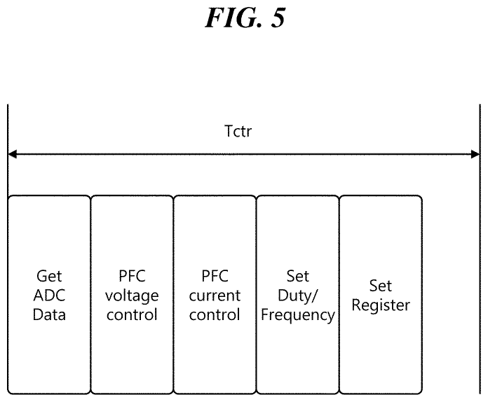

FIG. 5 illustrates an example diagram showing a control process performed by a single core during one control period.

Referring to FIG. 5, in each control period, the core may perform processes such as a process of acquiring sensing values from an Analog-Digital Converter (ADC), a voltage control process, a current control process, a control value setting process, and a register configuration process.

The converter controller may include a plurality of ADC channels. Each ADC channel may sense the current of each phase, the voltage of a DC link capacitor, the voltage of an output node, etc. and convert them into digital values. The core may acquire sensing values from the individual ADC channels during an initial time segment of each control period.

The core may perform PFC voltage control based on the acquired ADC sensing values. For example, the core may perform a PFC voltage control process to execute a control algorithm designed to compare a sensed voltage value of the DC link capacitor with a reference voltage value and minimize the difference between the two values.

The core may perform PFC current control based on the ADC sensing values and the result values of the PFC voltage control process. For example, the core may perform a PFC current control process to execute a control algorithm that uses the sensed current value of each phase and the result value calculated in the PFC voltage control process to maintain the current value of each phase at a consistent level.

The core may calculate control values for Pulse Width Modulation (PWM) signals for each switch—for example, duty cycle and period-based on the result values of the PFC current control process, and may store the calculated values in a predefined data variable.

The core may read the values stored in the predefined data variable, may calculate the register values based on these values, and may configure the registers with the calculated values.

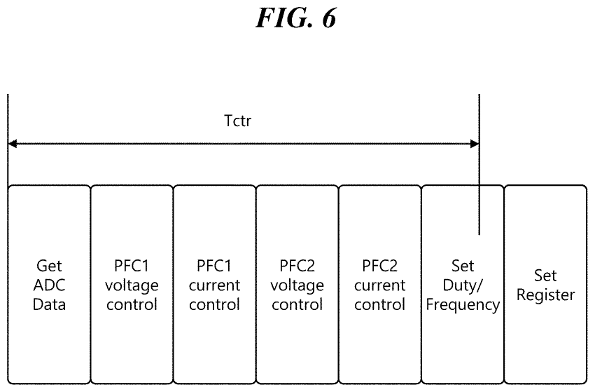

FIG. 6 is a diagram illustrating a problem that may arise when a single core simultaneously controls two PFC (power factor correction) circuits during one control period.

Referring to FIG. 6, a single core may control two PFC circuits. In this case, the core needs to calculate control values separately for each PFC circuit, which may require performing the PFC voltage control process and the PFC current control process twice.

After performing the process of acquiring sensing values from an Analog-to-Digital Converter (ADC), the core may first execute the voltage control process and current control process for the first PFC circuit. Then, the core may perform the voltage control process and current control process for the second PFC circuit. Once the control values for each PFC circuit have been calculated, the core may perform the control value setting process and the register configuration process.

However, there is a possibility that a single core may not be able to complete all these processes within a single control period. In particular, if the core is optimized for controlling a single PFC circuit, attempting to control two or more PFC circuits with the same core may result in a failure to perform every process within one control period.

To address this issue, the converter controller according to one embodiment may use two cores to control each PFC circuit independently.

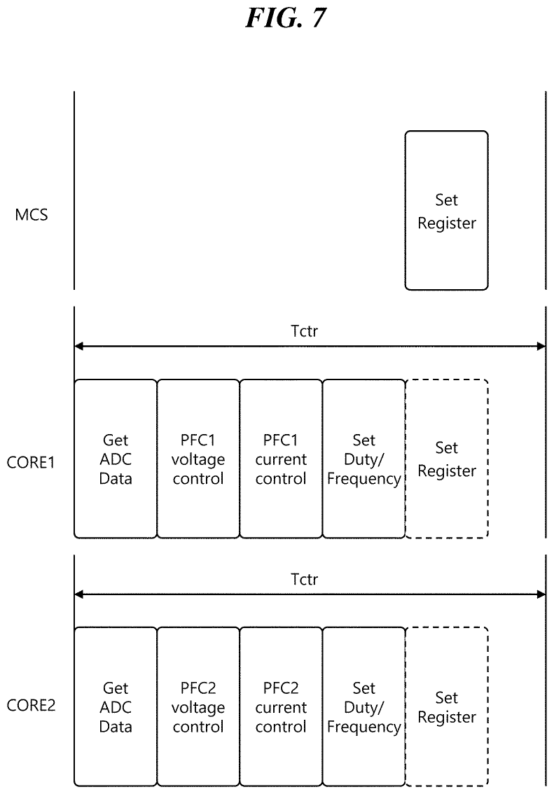

FIG. 7 is a diagram illustrating how two cores in a converter controller according to one embodiment control respective PFC circuits.

Referring to FIG. 7, the first core may perform a process of acquiring sensing values from the Analog-to-Digital Converter (ADC) connected to the first PFC circuit. The first core may then perform the voltage control process and current control process for the first PFC circuit. Additionally, the first core may set the control values required for the first PFC circuit. Also, the first core may not perform the process of updating registers. The process of updating registers may be performed by a third core (MCS:
Multi Channel Sequencer).

The second core may perform a process of acquiring sensing values from the ADC connected to the second PFC circuit. Then, the second core may execute the voltage control process and current control process for the second PFC circuit. Afterward, the second core may perform the control value setting process required for the second PFC circuit. Also, the second core may not perform the process of updating the registers. The process of updating the registers may be performed by the third core (MCS).

At this time, if the first core and the second core each independently perform the register configuration process, there is a possibility that a problem may arise. When the first and second cores each perform the register configuration process, one core may properly configure the registers, while the other core may fail to do so. For example, the first core may complete the register configuration properly, but the second core may fail to complete the process.

In such cases, the first and second PFC circuits may be controlled without maintaining data coherence. As a result, control values such as switching period may not be synchronized, potentially causing excessive current to flow through a particular circuit.

To address this issue, a method may be applied in which a single core (e.g., the third core) configures registers for both of the two PFC circuits. The first core may read the control values calculated by the second core, calculate the register values based on the calculated control values, and then configure the registers for the first PFC circuit and the second PFC circuit.

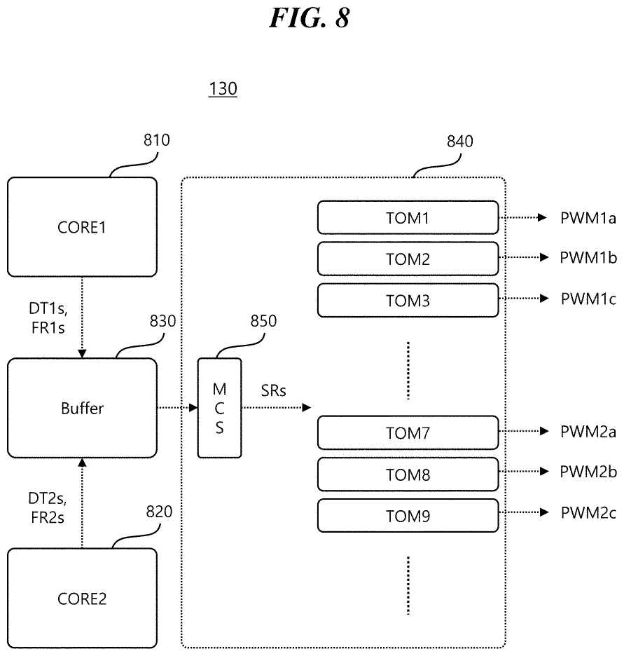

FIG. 8 is a configuration diagram of a converter controller according to one embodiment.

Referring to FIG. 8, the converter controller 130 may include a first core 810, a second core 820, a buffer 830, and a timer module 840.

The converter controller 130 may be configured in the form of a micro-controller unit (MCU).

The MCU is an integrated circuit for an embedded system that may include one or more processor cores. These cores may have a structure capable of performing 8-bit, 16-bit, 32-bit, or higher bit data processing. Depending on the requirements of a specific application, the MCU may be designed to include multiple 32-bit cores. Such a design may offer the potential for parallel processing and high-performance computational tasks.

The MCU may be configured as a hardware and software platform for use in automotive and industrial applications. The MCU may function in environments that require high-performance computation, communication, and data processing. Through this, the MCU may be used to control various sensors and actuators and to execute complex control algorithms. The MCU may contribute to enhancing system stability and efficiency by generating control signals or processing data.

The MCU may support functional safety at the ISO 26262 Automotive Safety Integrity Level-D (ASIL-D) level. This standard defines the requirements necessary to ensure safe operation in automotive applications. In accordance with these requirements, the MCU may include fault diagnosis, error detection, and recovery functions. Through this, it is possible to meet the hardware and software design elements needed to enhance the safety of automotive systems.

The MCU may comply with the Automotive Open System Architecture (AUTOSAR) 4.2 standard. This standard defines the software architecture of automotive electronic control units (ECUs), and the MCU may perform integrated functions within this architecture. By complying with AUTOSAR, the MCU may provide a software platform that ensures interoperability among various suppliers and systems.

The MCU may include communication interfaces, data processing capability, and security features. The communication interfaces may include Controller Area Network (CAN), Local Interconnect Network (LIN), FlexRay, and Ethernet, through which the MCU can exchange data with an external device. The data processing capability may vary depending on the performance of the cores included in the MCU and the memory size. Additionally, the MCU may provide hardware security features such as an encryption module or security authentication.

The MCU may perform sensor data collection and processing and actuator control through various input and output interfaces. This enables the MCU to support conversion tasks between the physical world and digital signals. Additionally, the MCU may include functions such as Analog-to-Digital Converter (ADC), Digital-to-Analog Converter (DAC), and Pulse Width Modulation (PWM), allowing for various control and conversion tasks.

The MCU may include built-in memory and storage. Program code and data may be stored using embedded flash memory or Electrically Erasable Programmable Read-Only Memory (EEPROM), and Random Access Memory (RAM) may be included to process data required during execution. This memory architecture may be designed in various ways to meet the requirements of the application.

The first core 810 and the second core 820 each may be one of the plurality of cores included in the MCU.

The first core 810 may acquire ADC sensing values in each control period, and may perform voltage control and current control processes for the first PFC circuit to calculate PWM control values—for example, first duty cycle values DT1s and first period values FR1s—for the first switches included in the first PFC circuit. The first core 810 may then store the control values DT1s and FR1s for the first switches in a first data variable included in the buffer 830.

The second core 820 may acquire ADC sensing values in each control period, and may perform voltage control and current control processes for the second PFC circuit to calculate PWM control values—for example, second duty cycle values DT2s and second period values FR2s—for the second switches included in the second PFC circuit. The second core 820 may then store the control values DT2s and FR2s for the second switches in a second data variable included in the buffer 830.

Here, the buffer 830 may be shared by the first core 810 and the second core 820. Accordingly, the first core 810 and the second core 820 may access not only the first data variable but also the second data variable.

The timer module 840 may have the form of a Generic Timer Module (GTM).

The GTM may be a hardware module capable of performing complex timing and event control tasks in embedded systems. This module may include various channels, and can be used in applications that require precise time-based control. The GTM may provide hardware-based timing management functions that support tasks such as input signal processing, output signal generation, and timing control.

The GTM may include submodules. These submodules may include sub-structures such as Timer Output Module (TOM), Advanced Timer Output Module (ATOM), Timer Input Module (TIM), and Time Base Unit (TBU). TOM is a module that supports Pulse Width Modulation (PWM) signal generation, and may be designed to allow independent control for each channel. ATOM is a timing control module that can provide higher precision and flexibility than TOM. TIM may process input signals to detect timing events or capture time data. TBU provides a time base that serves as a reference for timer operation.

The GTM may include an integrated clock management mechanism. A Clock Management Unit (CMU) may provide clock signals suitable for each submodule of the module, and may control the frequency and accuracy of the timer. Through this, the GTM may support operations suitable for various timing requirements.

The GTM may support multi-channel operation. This allows the timer module 840 to process multiple input and output signals simultaneously, with each channel being independently configured and controlled.

The timer module 840 may include a plurality of TOMs (TOM1, TOM2, TOM3, . . . TOM7, TOM8, TOM9, . . . ). Each TOM channel (TOM1, TOM2, TOM3, . . . , TOM7, TOM8, TOM9, . . . ) may output a single PWM signal (PWM1a, PWM1b, PWM1c, . . . , PWM2a, PWM2b, PWM2c, . . . ) to control the on/off state of a corresponding switch. For example, the first TOM channel (TOM1) may output a first PWM a-phase signal (PWM1a), the second TOM channel (TOM2) may output a first PWM b-phase signal (PWM1b), and the third TOM channel (TOM3) may output a first PWM c-phase signal (PWM1c). The seventh TOM channel (TOM7) may output a second PWM a-phase signal (PWM2a), the eighth TOM channel (TOM8) may output a second PWM b-phase signal (PWM2b), and the ninth TOM channel (TOM9) may output a second PWM c-phase signal (PWM2c).

The Generic Timer Module (GTM) may include a Multi Channel Sequencer (MCS) 850. The GTM is a hardware module that enables timer-based precise signal processing and control in embedded systems, and the MCS 850 may be designed as a submodule of this module. The MCS 850 may provide a sequencing function for handling various input signals and output signals via multiple channels.

The MCS 850 may include a function that allows it to sequentially process signals based on timer values, comparison values, and input conditions through a programmable sequencer. This means that the MCS 850 can be used to set various timing conditions and trigger a particular operation. Through its programmable architecture, users can define sequencing operations according to the requirements of specific applications.

The MCS 850 may operate in conjunction with other submodules within the GTM. The MCS 850 may provide trigger signals to a timer-based submodule such as Timer Output Module (TOM) or Advanced Timer Output Module (ATOM) or may receive input data from these submodules and process it. This interconnected structure may enable the MCS 850 to contribute to the overall timing and event control functionality of the GTM.

The MCS 850 may support condition-based operations. Based on a particular input event, the arrival of a timer value, or a register value comparison result, the MCS 850 may determine the next operation or trigger other submodules. This allows the MCS 850 to operate flexibly in response to real-time changing conditions.

The PWM control values generated by the first core 810 and the second core 820 may be set in registers by the third core, in which case the third core may be implemented as the MCS. The MCS, operating as the third core, may perform all functions of the third core.

The MCS 850 may include Random Access Memory (RAM). The RAM may provide memory space that the MCS 850 can be used to store or process data required during operation. By utilizing the RAM, the MCS 850 may have a structure capable of temporarily storing data related to the instruction being executed and storing and managing computation results.

The RAM may be used in conjunction with a program counter and instruction execution logic within the MCS 850. The MCS 850 may provide memory space to store variables related to the task being executed, or to temporarily keep register values and intermediate computation results. Through this, the MCS 850 may efficiently handle complex computational tasks and conditional trigger operations.

The RAM may be configured as a memory block that may operate independently within the MCS 850. The RAM may be designed to read and write and be mapped to a specific address space, allowing the MCS 850 to access it at the hardware level. During instruction execution, the MCS 850 may use the RAM to perform a data storage or retrieval operation.

The RAM may be used to ensure continuity between the data and instructions processed by the MCS 850. The RAM may operate in conjunction with the computational unit or trigger logic of the MCS 850 at the hardware level, thereby potentially processing data in real time. In addition, the RAM may provide a mechanism that allows the MCS 850 to individually store and manage the status or results of each channel while processing multi-channel data simultaneously.

The first core 810 and the second core 820 may access the RAM area of the MCS 850. A first variable and a second variable may be located in the RAM area. The first core 810 or the second core 820 may check the values of a first data variable and a second data variable located in the buffer 830, and may transmit the value of the first data variable to the first variable located in the RAM area of the MCS 850 and the value of the second data variable to the second variable. Then, the MCS 850 may check the values of the first and second variables located in the RAM area, may calculate register values for PWM signal output based on those values, and may configure the registers for PWM signal output using the register values.

The PWM control values may include, for example, at least one of a value indicating the duty cycle of the PWM signal and a value indicating the period of the PWM signal. The register values may be a rising edge time value and/or falling edge time value of the PWM signal, or a time value representing the period of the PWM signal. The MCS 850 may check the PWM control values stored in the first and second variables, and, based on these values, may calculate the rising edge time value of the PWM signal, the falling edge time value of the PWM signal, and the time value representing the period of the PWM signal. The MCS 850 may then set the calculated rising edge time value of the PWM signal, the calculated falling edge time value of the PWM signal, and the calculated time value representing the period of the PWM signal in shadow registers respectively corresponding to the TOMs.

Each TOM may include a first CM register used for setting the rising edge of the PWM signal, a second CM register used for setting the falling edge, and a first CN register used for setting the period of the PWM signal. The values stored in the shadow register may be transmitted to the first CM register, the second CM register, and the first CN register at the start of a control period.

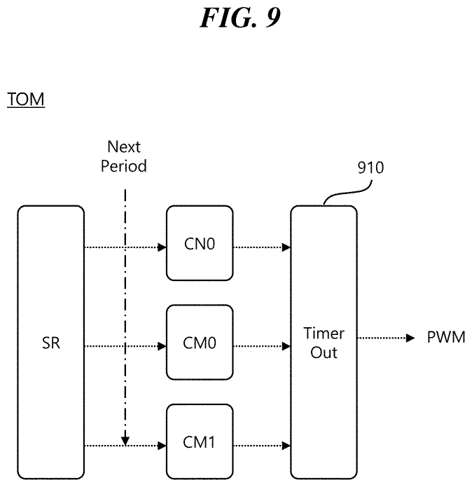

FIG. 9 is a configuration diagram of a TOM channel according to an embodiment.

Referring to FIG. 9, the TOM channel may include registers such as a shadow register (SR), a first CN register (CN0: Compare Number Register 0), a first CM register (CM0: Compare Match Register 0), and a second CM register (CM1: Compare Match Register 1). The TOM channel may perform timer-based signal processing through these registers. Each register may perform a specific function in the process of generating or outputting a PWM (Pulse Width Modulation) signal.

The shadow register SR may be used as a space for temporarily storing values during operation. It helps prevent immediate impact on timer output when the register values are changed, and it provides a structure that allows new values to be applied reliably. This allows for a design that contributes to maintaining signal continuity and stability in the process of generating PWM signals.

The first CN register CN0 may be configured as a register for storing or comparing the current value of a timer. It may be used to check the current state of the timer or determine whether the value of the timer has reached a specific reference. CN0 stores values related to a timer period, and may serve as a reference value needed to generate a PWM signal period.

The first CM register CM0 and the second CM register CM1 may be used to store a reference value to be compared with a value of the timer. CM0 may be used to switch the PWM signal to a high state or trigger a specific operation when the value of the timer reaches a certain point. CM1 may be used to switch the PWM signal to a low state or perform another operation when the value of the timer reaches another specific point. The duty cycle and period of the PWM signal may be determined based on the values of these two registers.

The TOM channel may include an output unit 910 that generates PWM signals based on the setting values of the registers. The output unit may process timer events based on the register values and generate PWM signals and transmit them to an external system. The output unit, which is a block that is designed at the hardware level, is controlled by the register values, and may operate in a way that ensures the accuracy and coherence of the PWM signals.

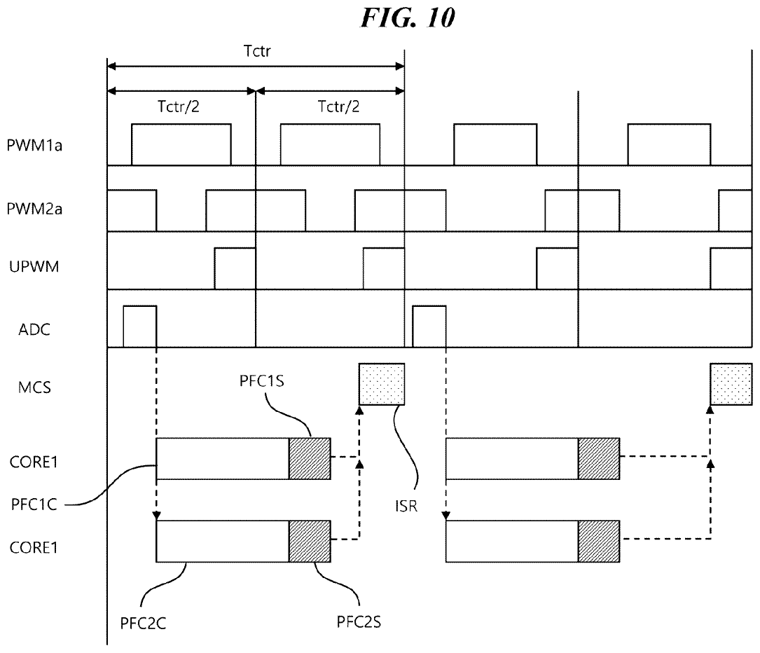

FIG. 10 is a diagram illustrating a procedure for cores to perform processes and waveforms of primary signals according to one embodiment.

Referring to FIG. 10, the ADC may perform sensing during an initial time segment of each control period. Then, based on a sensing-completion interrupt signal from the ADC, the first core may perform a first control process (PFC1C), and the second core may perform a second control process (PFC2C).

In the first control process (PFC1C), the first core may calculate the PWM control values for the first switches included in the first PFC circuit. In the first control process (PFC1C), the first core may perform the process of acquiring sensing values from the ADC for the first PFC circuit, the voltage control process, and the current control process and then calculate the PWM control values for the first switches. The first control process (PFC1C) may be performed for each control period.

In the second control process (PFC2C), the second core may calculate the PWM control values for the second switches included in the second PFC circuit. In the second control process (PFC2C), the second core may perform the process of acquiring sensing values from the ADC for the second PFC circuit, the voltage control process, and the current control process and then calculate the PWM control values for the second switches. The second control process (PFC2C) may be performed for each control period.

After performing the first control process (PFC1C), the first core may store the calculated PWM control values for the first switches in the first data variable located in the buffer (PFC1S). After performing the second control process (PFC2C), the second core may store the calculated PWM control values for the second switches in the second data variable located in the buffer (PFC2S).

Of the first core and the second core, the core that stores the PWM control values later may trigger the Interrupt Service Routine (ISR) of the third core, for example, the MCS. In the ISR, the third core may configure registers for PWM signal output to the first switches based on the value of the first data variable and may configure registers for PWM signal output to the second switches based on the value of the second data variable.

Meanwhile, of the first core and the second core, the core that stores the PWM control values later may store the values of the first data variable and the second data variable in variables located in the RAM area of the third core. Then, in the ISR, the third core may check the variables located in the RAM area and may configure the registers. Since multiple cores may access the same variable simultaneously, conflicts may occur during the process of changing and reading the values of the variables. To resolve this issue, the converter controller according to one embodiment may prevent two or more cores from accessing a single variable simultaneously by locking and releasing access to the variable. A spinlock may be used for such locking and release operations.

For example, of the first core and the second core, the core that stores the PWM control values later may store the values of the first data variable and the second data variable in variables located in the RAM area of the third core and then trigger the ISR of the third core. In this case, when storing the values of the first and second data variables in variables located in the RAM area of the third core, the core triggering the ISR may use a spinlock. This core may first lock the spinlock to prevent the third core from accessing the variables, store the values of the first and second data variables in the variables, and then release the spinlock.

In another example, the third core may check the values of the variables located in the RAM area to calculate register values for PWM signal output, and then may configure the registers for PWM signal output using the calculated register values. In this case, a spinlock may be used to prevent the first core or the second core from changing the variables located in the RAM area. The third core may first lock the spinlock to block access to the variables by the first or second core, use the variable values to configure the registers, and then release the spinlock.

In order to ensure data coherence, the converter controller according to one embodiment may be configured such that, of the first core and the second core, the core that stores the PWM control values later checks both the first data variable and the second data variable and then transmits them to the third core. In this case, the first core and the second core may check the value of a state variable to determine which core stores first and which core stores later.

The state variable may be a variable shared between the first core and the second core, and may be located in the buffer. The state variable may have four possible values. A first value may indicate an initial state, and may be represented by the number 1. A second value may indicate that the PWM control values for the first switches are stored in the first data variable, representing that the first core has completed storage, and may be represented by the number 2. A third value may indicate that the PWM control values for the second switches are stored in the second data variable, representing that the second core has completed storage, and may be represented by the number 3. A fourth value may indicate that the PWM control values for the first switches are stored in the first data variable, and that the PWM control values for the second switches are stored in the second data variable, representing that both the first and second cores have completed storage, and may be represented by the number 4. The state variable may have one of these four values.

The first core and the second core may change the value of the state variable based on the result of their operation. In this case, to prevent the two cores from accessing the state variable simultaneously, a spinlock may be used. When the first core accesses the state variable, it may first lock the spinlock and then access the state variable. When the second core accesses the state variable, it may first lock the spinlock and then access the state variable.

The first core and the second core may determine which core stores first and which core stores later based on the value of the state variable.

The first core and the second core each may perform a step of checking whether the state variable holds a first value. In this step, if the state variable does not hold the first value, a process of triggering the ISR of the third core may be performed. For example, if the first core finds that the state variable holds the first value, it may change the state variable to a second value. Then, if the second core finds that the state variable holds the second value, it may determine that the first core stored first and changed the state variable to the second value. As the second core is the core that stores later, it may then perform the process of triggering the ISR of the third core. Conversely, if the second core finds that the state variable holds the first value, it may change the state variable to a third value. Then, if the first core finds that the state variable holds the third value, it may determine that the second core stored first and changed the state variable to the third value. As the first core is the core that stores later, it may then perform the process of triggering the ISR of the third core. This step may be performed using a spinlock to prevent the first and second cores from accessing the state variable simultaneously.

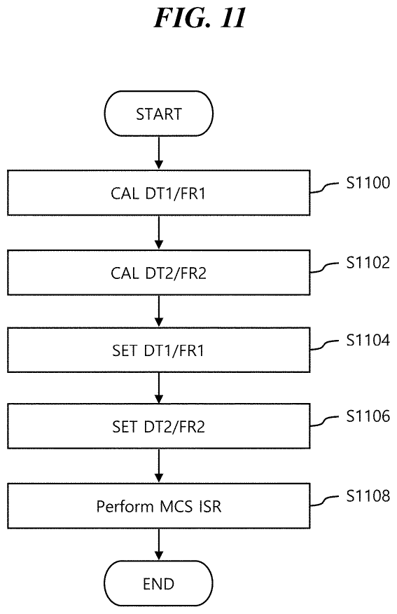

FIG. 11 is a flowchart illustrating a converter control method according to one embodiment.

Referring to FIG. 11, the first core may calculate PWM control values for the first switches included in the first PFC circuit (S1100). The PWM control values may include at least one of a value indicating the duty cycle of the PWM signal and a value indicating the period of the PWM signal.

Then, the second core may calculate PWM control values for the second switches included in the second PFC circuit (S1102).

Then, the first core may store the PWM control values for the first switches in a first data variable and may check and change the value of a state variable (S1104).

Then, the second core may store the PWM control values for the second switches in a second data variable and may check and change the value of the state variable (S1106).

At this point, the core that stores the PWM control values later may trigger the ISR of the third core. In the ISR, the third core may configure registers for PWM signal output to the first switches based on the value of the first data variable, and may configure registers for PWM signal output to the second switches based on the value of the second data variable (S1108).

In the step where the first core checks and changes the value of the state variable (S1104), the first core may check the value of the state variable. If the value of the state variable is the first value, the first core may change the value of the state variable to the second value. Alternatively, if the value of the state variable is the third value, the first core may change the value of the state variable to the fourth value. In the step where the second core checks and changes the value of the state variable (S1106), the second core may check the value of the state variable. If the value of the state variable is the first value, the second core may change the value of the state variable to the third value. Alternatively, if the value of the state variable is the second value, the second core may change the value of the state variable to the fourth value.

According to this method, the core that changes the value of the state variable to the fourth value may be the core that stores the PWM control values later. Accordingly, the core that changes the value of the state variable to the fourth value may trigger the ISR of the third core.

Furthermore, before triggering the ISR of the third core, the core that changes the value of the state variable to the fourth value may store the value of the first data variable and the value of the second data variable in variables located in the random access memory (RAM) area of the third core. Then, in step S1108, the third core may read the values of the variables located in the RAM area and configure the registers.

The core that changes the value of the state variable to the fourth value may lock a spinlock to prevent conflicts with the third core, and then may store the value of the first data variable and the value of the second data variable in variables located in the RAM area of the third core.

The first core and the second core may also lock a spinlock and then may check the value of the state variable, in order to prevent mutual conflicts.

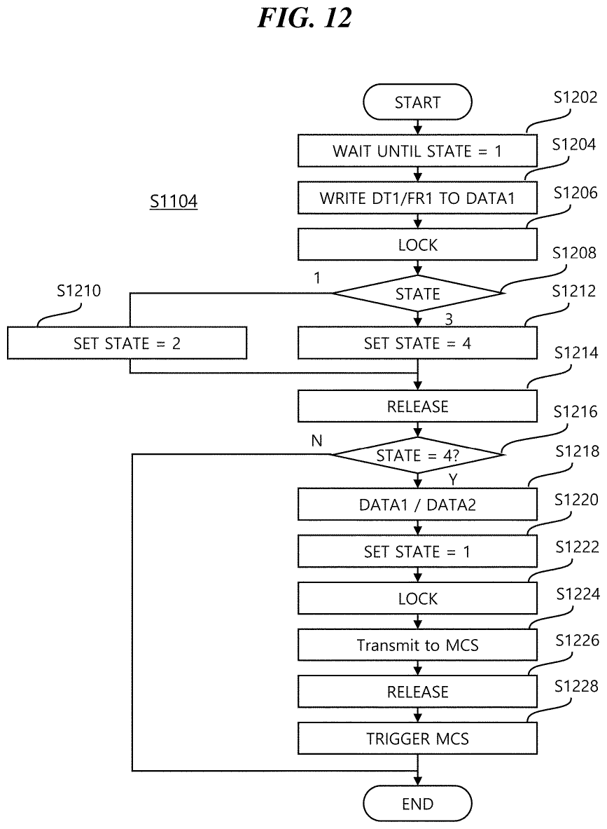

FIG. 12 is a detailed flowchart of step S1104 in the flowchart in FIG. 11.

Referring to FIG. 12, the first core may wait until the state variable (STATE) becomes the first value (1) (S1202).

Once the state variable (STATE) becomes the first value (1), the first core may store the PWM control values DT1 and FR1 for the first switches in the first data variable (DATA1) (S1204).

Then, the first core may lock the spinlock (S1206) and may perform the process of checking and changing the value of the state variable.

In the process of checking and changing the value of the state variable, the first core may check the value of the state variable (S1208).

If the value of the state variable is the first value (1) (1 at S1208), the first core may change the state variable to the second value (2) (S1210). If the value of the state variable is the third value (3), the first core may change the state variable to the fourth value (4) (S1212).

After completing the process of checking and changing the value of the state variable, the first core may release the spinlock (S1214).

Then, the first core may compare the value of the state variable with the fourth value (4) (S1216). If the value of the state variable is not the fourth value (4) (N in S1216), the first core may terminate the procedure of S1104.

On the other hand, if the value of the state variable is the fourth value (4) (Y in S1216), the first core may check the value of the first data variable (DATA1) and the value of the second data variable (DATA2) (S1218).

Then, the first core may initialize the value of the state variable to the first value (1) (S1220).

Then, the first core may lock the spinlock (S1222) and may transmit the value of the first data variable (DATA1) and the value of the second data variable (DATA2) to the RAM area of the third core, e.g., MCS (S1224). After that, the first core may release the spinlock (S1226).

Furthermore, the first core may trigger the ISR of the third core. The process from S1218 to S1228 may be referred to as the process of triggering the ISR of the third core.

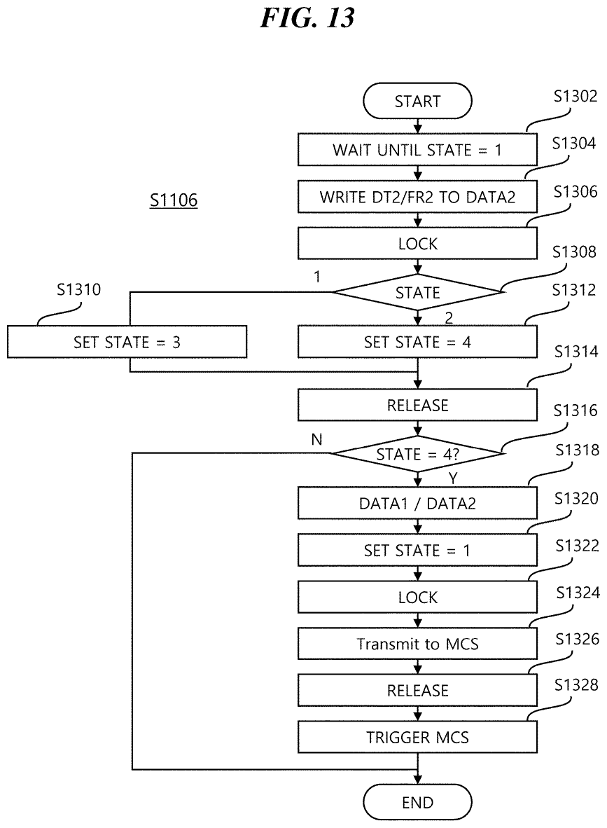

FIG. 13 is a detailed flowchart of step S1106 in the flowchart of FIG. 11.

Referring to FIG. 13, the second core may wait until the state variable (STATE) becomes the first value (1) (S1302).

Then, after the state variable (STATE) becomes the first value (1), the second core may store the PWM control values (DT2, FR2) of the second switches in the second data variable (DATA2) (S1304).

Then, the second core may lock the spinlock (S1306) and may perform a process of checking and changing the value of the state variable.

In the process of checking and changing the value of the state variable, the second core may check the value of the state variable (S1308).

If the value of the state variable is the first value (1) (1 in S1308), the second core may change the state variable to the third value (3) (S1310). If the value of the state variable is the second value (2) (2 in S1308), the second core may change the state variable to the fourth value (4) (S1312).

After completing the process of checking and changing the value of the state variable, the second core may release the spinlock (S1314).

Then, the second core may compare the value of the state variable with the fourth value (4) (S1316). If the value of the state variable is not the fourth value (4) (N in S1316), the second core may terminate the procedure of S1106.

On the other hand, if the value of the state variable is the fourth value (4) (Y in S1316), the second core may check the value of the first data variable (DATA1) and the value of the second data variable (DATA2) (S1318).

Then, the second core may initialize the value of the state variable to the first value (1) (S1320).

Then, the second core may lock the spinlock (S1322) and may transmit the value of the first data variable (DATA1) and the value of the second data variable (DATA2) to the RAM area of the third core, e.g., MCS (S1324). After that, the second core may release the spinlock (S1326).

Furthermore, the second core may trigger the ISR of the third core. The process from S1318 to S1328 may be referred to as the process of triggering the ISR of the third core.

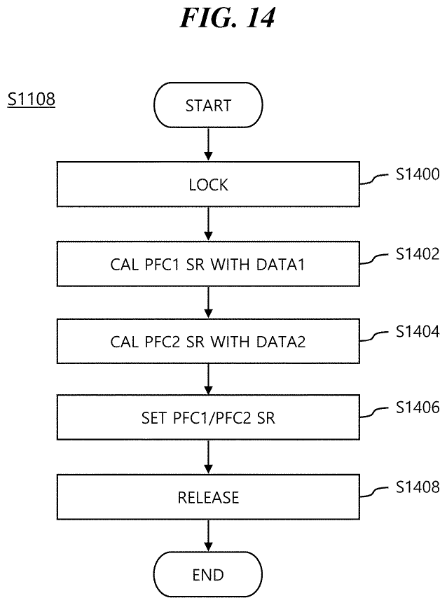

FIG. 14 is a detailed flowchart of step S1108 in the flowchart of FIG. 11.

The step of S1108 may be performed in the ISR of the third core, for example, MCS.

Referring to FIG. 14, the third core may lock the spinlock (S1400) and may calculate register values (PFC1 SR) for PWM signal output to the first switches based on the value of the first data variable stored in the first variable of the RAM area (S1402). For example, the third core may calculate a first CN register value so as to correspond to a value indicating the period of a PWM signal included in a PWM control value, and may calculate a first CM register value and a second CM register value so as to correspond to a value indicating the duty cycle of the PWM signal included in the PWM control value. The first CM register value may be a value used for setting the rising edge of the PWM signal—for example, a rising edge time value, and the second CM register value may be a value used for setting the falling edge of the PWM signal—for example, a falling edge time value.

The third core may calculate register values (PFC2 SR) for PWM signal output to the second switches based on the value of the second data variable stored in the second variable of the RAM area (S1404). For example, the third core may calculate the first CN register value so as to correspond to a value indicating the period of the PWM signal included in the PWM control value, and may calculate the first CM register value and the second CM register value so as to correspond to a value indicating the duty cycle of the PWM signal included in the PWM control value. The first CM register value may be a value used for setting the rising edge of the PWM signal—for example, a rising edge time value, and the second CM register value may be a value used for setting the falling edge of the PWM signal—for example, a falling edge time value.

Then, the third core may configure the registers for PWM signal output based on the calculated register values (S1406). For example, the third core may store the first CN register value in one shadow register corresponding to the first CN register. The value stored in this one shadow register may be transmitted to the first CN register at the start of the next control period. Additionally, the third core may store the first CM register value in another shadow register corresponding to the first CM register, and may store the second CM register value in yet another shadow register corresponding to the second CM register. The value stored in the another shadow register and the value stored in the yet another shadow register may be transmitted to the first CM register and the second CM register, respectively, at the start of the next control period.

The third core may release the spinlock (S1408).

As described above, according to the present disclosure, a plurality of PFC circuits may be controlled in synchronization. Furthermore, according to the present disclosure, it is possible to ensure data coherence when a plurality of PFC circuits are controlled by different cores.

As used herein, terms such as “include”, “comprise,” or “have” should be interpreted as indicating the possibility of inclusion, unless explicitly stated otherwise, and therefore should not be construed as excluding other components but rather as allowing the inclusion of additional components. All terms, including technical and scientific terms, should be interpreted as having the meanings commonly understood by those of ordinary skill in the art to which the present disclosure pertains, unless otherwise defined. Commonly used terms, such as those defined in dictionaries, should be interpreted in accordance with their contextual meaning in the relevant technical field, and unless expressly defined in the present disclosure, should not be interpreted in an idealized or overly formal sense.

The foregoing description is merely illustrative of the technical concept of the present disclosure, and those having ordinary skill in the art to which the disclosure pertains should understand that various modifications and alterations may be made without departing from the essential characteristics of the present disclosure. Accordingly, the embodiments disclosed herein are intended to explain, not to limit, the technical concept of the disclosure, and the scope of the technical concept should not be construed as being restricted by these embodiments. The scope of protection of the present disclosure shall be interpreted based on the claims below, and all technical concepts falling within an equivalent scope shall be construed as being included within the scope of rights of the present disclosure.

What is claimed is:

1. A converter controller comprising:
a first core configured, in each control period, to:
determine pulse width modulation (PWM) control values for first switches included in a first power factor correction (PFC) circuit; and
store the PWM control values for the first switches in a first data variable;
a second core configured, in each control period, to:
determine PWM control values for second switches included in a second PFC circuit; and
store the PWM control values for the second switches in a second data variable; and
a third core configured, in an Interrupt Service Routine (ISR) triggered by a core that stores the PWM control values later, of the first core and the second core, to:
configure registers for PWM signal output to the first switches based on a value of the first data variable; and
configure registers for PWM signal output to the second switches based on a value of the second data variable.

2. The converter controller of claim 1, wherein the first core and the second core are configured to determine and change a value of a state variable to determine which core stores first and which core stores later.

3. The converter controller of claim 2, wherein the first core and the second core are configured to use a spinlock when changing the value of the state variable.

4. The converter controller of claim 2, wherein the first core and the second core are configured to determine whether the state variable holds a first value, and
wherein when the state variable does not hold the first value, the first core and the second core are configured to trigger the ISR.

5. The converter controller of claim 4, wherein, when the state variable holds the first value, the first core is configured to change the state variable to a second value, and
wherein, when the state variable holds the second value, the second core is configured to trigger the ISR.

6. The converter controller of claim 2, wherein the state variable includes one of a first value indicating an initial state, a second value indicating that the PWM control values for the first switches are stored in the first data variable, a third value indicating that the PWM control values for the second switches are stored in the second data variable, and a fourth value indicating that the PWM control values for the first switches are stored in the first data variable, and
wherein the PWM control values for the second switches are stored in the second data variable.

7. The converter controller of claim 1, wherein a core that triggers the ISR stores the value of the first data variable and the value of the second data variable in variables located in a random access memory (RAM) area of the third core, and then triggers the ISR.

8. The converter controller of claim 7, wherein the core that triggers the ISR uses a spinlock when storing the value of the first data variable and the value of the second data variable in variables located in the RAM area of the third core.

9. The converter controller of claim 8, wherein the third core is configured to:
determine register values for PWM signal output based on the values of the variables located in the RAM area of the third core; and
configure the registers for PWM signal output using the register values.

10. The converter controller of claim 9, wherein the third core is configured to use a spinlock when checking the values of the variables located in the RAM area of the third core.

11. The converter controller of claim 7, wherein the third core is configured to:
generate a rising edge time value or a falling edge time value of the PWM signal from the value of a variable located in the RAM area of the third core; and
store the rising edge time value or the falling edge time value in the registers for PWM signal output.

12. The converter controller of claim 1, wherein the PWM control values include at least one of a value indicating a duty cycle of the PWM signal or a value indicating a period of the PWM signal.

13. The converter controller of claim 1, further comprising timer output modules (TOMs) configured to output a PWM signal to the first switches and the second switches,
wherein the third core is configured to configure shadow registers (SR) respectively corresponding to the TOMs.

14. The converter controller of claim 13, wherein each TOM includes a first CM register used for setting a rising edge of the PWM signal and a second CM register used for setting a falling edge of the PWM signal, and
wherein values stored in the shadow register are transmitted to the first CM register and the second CM register at a start of a control period.

15. The converter controller of claim 14, wherein the TOMs are located in a Generic Timer Module (GTM), and
wherein the third core is a Multi Channel Sequencer (MCS) located in the GTM.

16. The converter controller of claim 1, wherein the first core is configured, in each control period, to:
acquire sensing values from an Analog-to-Digital Converter (ADC) for the first power factor correction (PFC) circuit;
perform a voltage control process;
perform a current control process; and
determine the PWM control values for the first switches, and
wherein the second core is configured, in each control period, to:
acquire sensing values from an ADC for the second PFC circuit;
perform a voltage control process;
perform a current control process; and
determine the PWM control values for the second switches.

17. A converter control method comprising:
determining, by a first core, pulse width modulation (PWM) control values for first switches included in a first power factor correction (PFC) circuit;
determining, by a second core, PWM control values for second switches included in a second PFC circuit;
storing, by the first core, the PWM control values for the first switches in a first data variable;
determining, by the first core, a value of a state variable;
changing, by the first core, the value of the state variable to a second value based on the value of the state variable being a first value, or changing, by the first core, the value of the state variable to a fourth value based on the value of the state variable being a third value;
storing, by the second core, the PWM control values for the second switches in a second data variable;
determining, by the second core, the value of the state variable;
changing, by the second core, the value of the state variable to the third value based on the value of the state variable being the first value, or changing, by the second core, the value of the state variable to the fourth value based on the value of the state variable being the second value;
configuring, by a third core, registers for PWM signal output to the first switches based on a value of the first data variable;
configuring, by the third core, registers for PWM signal output to the second switches based on a value of the second data variable; and
triggering an Interrupt Service Routine (ISR) of the third core by a core that changes the value of the state variable to the fourth value.

18. The converter control method of claim 17, further comprising:
before triggering the ISR of the third core, storing, by a core that changes the value of the state variable to the fourth value, the value of the first data variable and the value of the second data variable in variables located in random access memory (RAM) area of the third core.

19. The converter control method of claim 18, further comprising:
locking, by a core that changes the value of the state variable to the fourth value, a spinlock; and
storing, by the core that changes the value of the state variable to the fourth value, the value of the first data variable and the value of the second data variable in variables located in the RAM area of the third core.

20. The converter control method of claim 17, further comprising:
locking, by the first core and the second core, a spinlock; and
determining, by the first core and the second core, the value of the state variable.
